(19) United States
(12) Patent Application Publication
(10) Pub. No.: US 2007/0163516 A1
(43) Pub. Date: Jul. 19, 2007

(54) Intelligent scarecrow system for utilization in agricultural and industrial applications

(76) Inventor: Paul D'Andrea, Kanata (CA)

Correspondence Address: PYLE & PIONTEK, 221 N LASALLE - ROOM 2036, CHICAGO, IL, 60601, US

(21) Appl. No.: 11/335,306

(22) Filed: Jan. 19, 2006

(51) Int. Cl. A01K 37/00

(52) U.S. Cl. 119/713

(57) ABSTRACT

A bird, animal or the like deterrent system for monitoring and protecting an area from intrusion to be utilized in agricultural and industrial applications comprises one or plurality of vision control units, one or plurality of mobile robots, and one or plurality of wire tracks for the robots. The system is not prone to bird habituation such as static bird deterrents such as scare balloons, bird bangers loud speakers and predator decoys. It combines both movement and localized sounds to scare birds. It is easy to install and easy to maintain.

### BACKGROUND OF THE INVENTION

1. Field of Invention

The present invention relates to an area surveillance and deterrence system for utilization in agricultural and industrial applications.

2. Description of Prior Art

Bird deterrent methods fall into three main groups: acoustical, visual or physical.

Acoustical methods rely on sound to frighten birds away from sites. Examples include propane cannons, pyrotechnic guns, and electronic sound devices with pre-recorded bird alarm cries, distress cries, and predator noises. Birds have the same range of hearing as humans, so anything that works well to frighten a bird can also irritate a person. These methods are sometimes effective but usually only for a short time. The birds habituate to the repeated sounds rather quickly and the noise tends to irritate neighbors.

There are numerous visual repellents on the market. Examples of visual repellents include balloons, mylar streamers, vinyl owls or hawks, and kites. Visual repellents usually are only temporarily effective because birds quickly become accustomed to them and ignore them.

Physically restricting birds from the crop with netting is currently the most effective way to protect grapes. However there are several undesirable aspects to this approach. Netting is labor-intensive and consequently has associated issues with recruiting, hiring and retaining crews. Nets also need to be stored out of sunlight for most of the year, taking up space in the barn or garage. In some areas, it cost money to dispose of the netting.

Also known in the art are bird deterrent devices that attempt to detect the presence of birds before initiating any bird deterrence method. The objective is to minimize habituation by the birds by avoiding regular periodic deployment of the devices. However, these detection devices are non-selective. For example, one device uses Doppler radar to detect the presence of birds. However, any object entering the radar field, whether a bird, animal or a leaf in the wind, can trigger the bird deterrent methods.

The following prior United States patents are examples of the scarecrow systems:

| | |
|---|---|
| 4,109,605 | Scarecrow System; |
| 5,956,880 | Bird Repellent Apparatus; |
| 5,986,551 | Method and System for Preservation Against Pesky Birds |
| | and Pest Animals: |
| 5,892,446 | Wild Animal Deterrent System; |
| 5,450,063 | Bird Avert System; and |
| 5,997,866 | Bird Dispersing System |

### BRIEF SUMMARY OF THE INVENTION

The intelligent scarecrow system (ISS) is developed to solve the problem of keeping birds away from grapes in vineyards during the ripening season. It specifically addresses three main weaknesses with existing technologies. First, it is not prone to bird habituation such as the “static” bird deterrents such as scare balloons, bird bangers, loud speakers and predator decoys since it combines both movement and localized sounds to scare birds. Second, it is designed to be easy to install and easy to maintain, compared to the most effective bird deterrent available, netting, which requires several people and heavy machinery. Finally, it is beneficial for tourism since is does not conceal the grapes, like netting, and, only delivers localized sound (also appreciated by vineyard neighbors).

The ISS can be used effectively in other areas where bird presence is undesirable, for example, on roofs of buildings. Using ISS would prevent birds from nesting on the roofs and the like, where it is undesirable.

The ISS is built to provide protection in a patrolled area. It consists of three subsystems that work together in real-time to determine if birds are approaching and intruding into the patrolled area in order to deploy the deterrents only when necessary. These subsystems are: the vision control unit (VCU), the mobile robots (MR) and their associated wire tracks (WT).

The VCU provides bird detection and controls functionality for the whole ISS system.

Each WT provides the traveling route for one MR. A WT is built using two wires which are spread between two end-posts. The number of WTs installed depends on the size of a patrolled area. There can be one or plurality of WTs i.e. MRs used. In order to enable the VCU to precisely deploy MRs within the patrolled area, WTs are divided into deployment zones by using markers. End markers are used to indicate to an MR that it has reached the end of its WT. Position markers are placed along a WT at zone boundaries.

MRs are used to scare birds away. They are small mobile robots that quickly travel along the WT at the request of the VCU. They are used to scare birds away by their fast movement towards the birds. They have a sound system that emits localized sounds, to increase their effectiveness at scaring the birds. They are equipped with a position marker detection system which enables them to tell in which zone along a WT they are currently positioned.

The VCU is mounted on a pole overlooking a protected area and has connected to it a video camera. The camera provides digital images of the protected area, which are analyzed by image analysis software to determine if birds are present in the patrolled area and, if they are, to calculate the location in which they are congregating. Based on the calculated location of the birds, the VCU dispatches MBs by sending data to them wirelessly via an RF transmitter.

The VCU generates a command that contains the following information: The MR identification number, the number of zones in the MR's WT, the zone where the MR should start emitting sound, a destination zone where birds were detected, the zone where the MR should stop, and the sound from the list of pre-recorded sounds stored in the MR's memory.

Deployment of MRs is optimized to minimize the number of MRs dispatched and the travel distance of each MR in order to save their battery power. Additionally the severity of bird attack (the number of birds of a flock) determines how many MRs will be deployed.

When an MR receives a command it will travel to the determined zone and stop in it. The MR detects position markers while passing over them. The on-board processor controls MR movement and generates a command to stop at the prescribed stop zone, detected by reading and counting position markers. This way the on-board processor determines the zone number that it is entering. The on-board processor turns on the sound as instructed by the command sent by the VCU, when the MR passes through the zone(s) where it should emit sound.

The WT is supported at one end with a fixed end-post and on the other end by a fixed end-post with a tensioning system, which controls tension in the support wires. Between the end-posts, the wires are supported by intermediate supports to reduce sagging by using position plates mounted on the intermediate supports. The position plates have two roles. One is to keep the wires evenly spaced and the other is to provide position markers. Two or three position plates are installed close to each other at the end of each WT to mark the end of each WT. This way an end zone marker is implemented. At the boundary between two zones a single position plate, i.e. a zone boundary marker, is installed.

During long periods of inactivity the VCU randomly deploys MR(s). This is done similar to a normal deployment, except that the VCU randomly decides which zones to patrol as well.

The VCU monitors the level of illumination and adjusts image acquisition parameters to maintain the appropriate level of brightness and contrast for successful bird detection. It also analyses the illumination level to detect the time of day. When the illumination level reaches a pre-determined low level, the VCU switches to the “night” mode, and instructs the MRS to switch to the stand-by mode.

In the night mode all MRs are sent to the end zones of their WTs (parking zones) and the VCU acquires images less frequently to continue monitoring changes in illumination conditions. In the morning when the illumination level reaches the pre-set average value, the VCU turns the system to the normal operating mode.

Thus, according to a system aspect of the present invention, there is provided a bird, animal or the like surveillance and/or deterrence system, comprising: a video surveillance device (VSD); an image processing system (IPS) responsive to outputs of said VSD; means in said IPS for categorizing objects according to size and movement in a defined surveillance area of said VSD; and a mobile robot responsive to commands from said IPS for moving within said defined surveillance area to closely identify and or deter a moving object.

According to a method aspect of the present invention, there is provided a method for video surveillance of a defined surveillance area, comprising: providing a digital output of a video surveillance device (VSD); processing consecutive images from said VSD to identify moving objects; determining positions, directions and speed of said moving objects; and providing a data command to a mobile robot to perform a predetermined action within said defined surveillance area.

### BRIEF DESCRIPTION OF THE DRAWINGS

The accompanying drawings illustrate preferred embodiments of the present invention, according to the best modes presently devised, in which:

FIG. 1 is a side view of a simple ISS comprising all three major components a VCU, an MR and its associated WT, as mounted to protect the row of grape vines;

FIG. 2 is a block diagram of the VCU with an auxiliary personal computer (PC) connected to it with a cable;

FIG. 3 is a block diagram of the MR's on-board processor;

FIG. 4 is a cross-section view of the MR and its main components.

FIG. 5A is a side view of the MR's wheel guide arm assembly comprising two members, of which the lower one is affixed to the wheel that rolls along the lower wire of the WT;

FIG. 5B is a front view of the MR's wheel guide arm assembly attached to the MR;

FIG. 6 is a flow chart showing the steps of the bird detection process; and

FIG. 7 is a flow chart showing the steps of the MR control procedure.

### DETAILED DESCRIPTION OF THE INVENTION

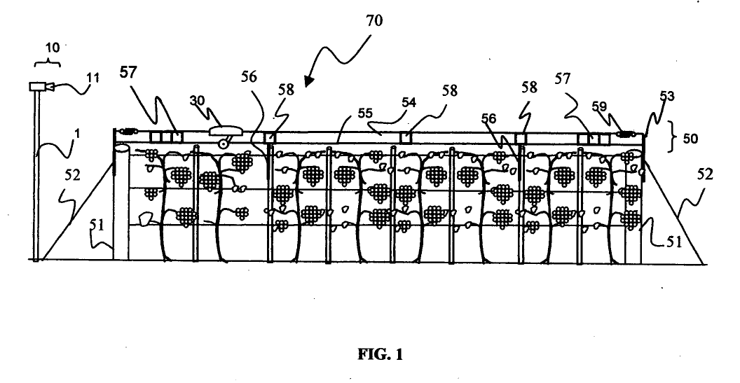

FIG. 1 illustrates a typical ISS system 70 comprising VCU 10, MR 30 and its associated WT 50.

The VCU 10 is mounted on a pole 1 and its camera 11 is installed in such a way, that its field of view covers the area which is to be protected. Once the position (pitch, yaw and pan) is set, the camera 11 is fixed at such position permanently.

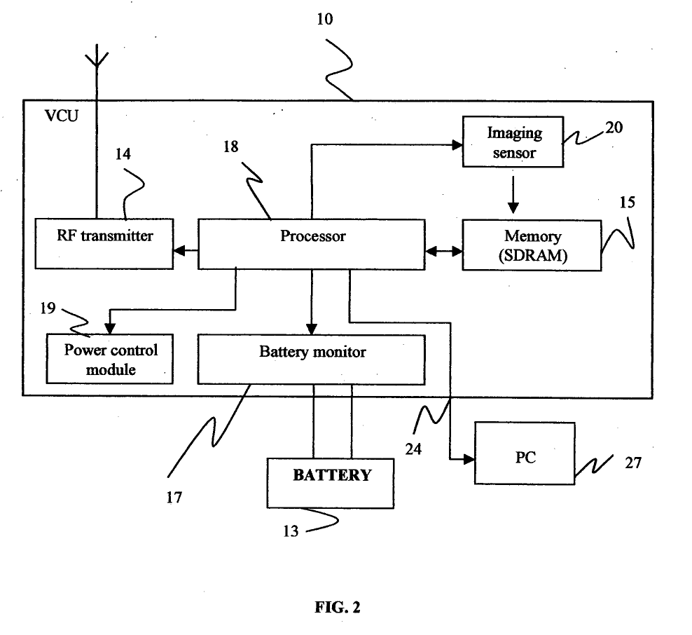

FIG. 2 is a block diagram of the VCU 10 with an auxiliary PC 27 connected to it via a cable 24. PC 27 is used for downloading bird detection data. Digital imaging sensor 20, which receives its input from the camera 11, generates images of the vineyard in real time and sends image data to a memory 15.

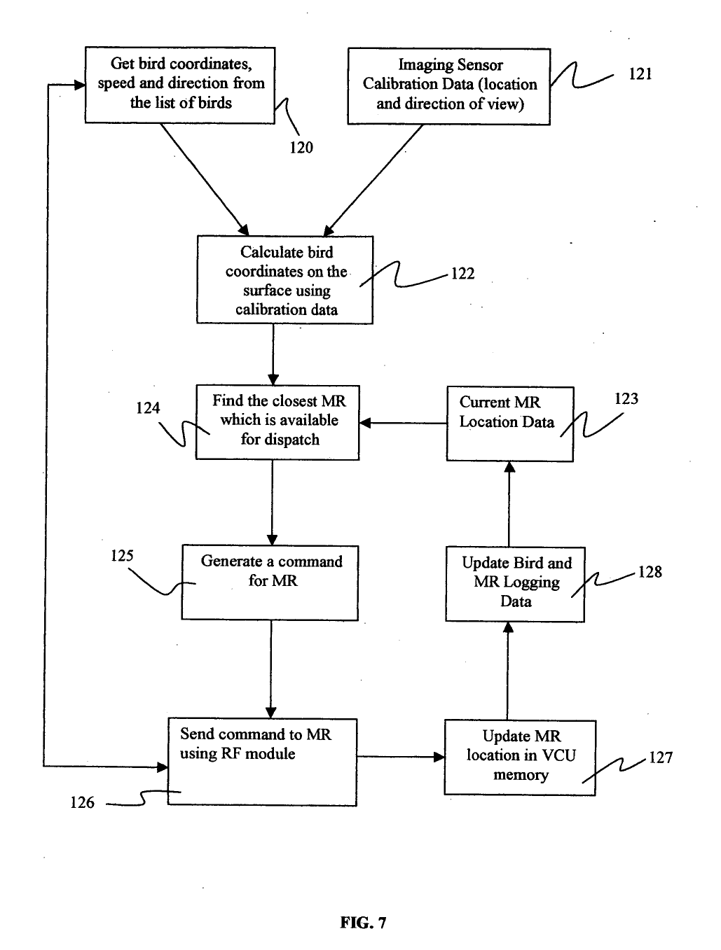

Processor 18 analyzes the digitally formatted sequence of images (or digital video) to detect birds and their coordinates in the image plane. When a bird is found, it will pass the bird's coordinates to the MR controller FIG. 7, which, in turn, will determine which MR 30 should be dispatched and where they should be sent. The command data is sent serially via an RF transmitter 14. The processor 18 is also responsible for analyzing the incoming frames to determine if it is night time or daytime in order to put the VCU 10 in standby mode to save power, and to send the MRs 30 to their parking position at the end of WTs 50. The processor 18 determines the current illumination level by processing the images and adjusts image acquisition parameters to compensate for changes in illumination due to clouds and time of day.

Battery monitor 17 is used to inform the processor 18 of the state of the batteries, and may produce an audible or other warning signal if battery 13 (housed inside the MR 30) is low.

The processor 18 is also responsible for enabling, disabling and communicating with every other module in the VCU 10.

Power control module 19 turns on and off the VCU 10 modules except the processor 18 and the memory 15. They remain operational to process the images and determine change in light conditions (day/night).

The ISS 70 has the following modes of operation:
a. Patrol Mode is the normal operation mode, when images are acquired and processed in real time, and commands are sent to MRs 30 according to the bird detection procedure shown in FIG. 7;
b. Sleep Mode is the stand-by mode, when nighttime is detected by the VCU 10, and the MRs 30 are sent to their parking zones at the end of the WTs 50.

The MRs 30 are used to scare birds by quickly traveling along the WT 50 towards intruding birds while emitting sounds designed to scare the birds.

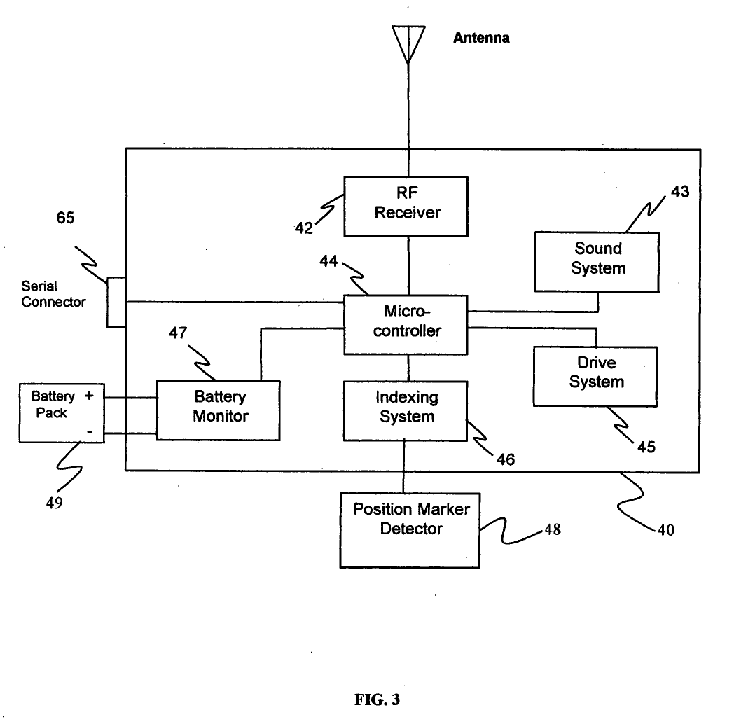

The controller MR 30 (FIG. 3) is battery powered. They may be recharged using solar panel rechargers (not shown), to provide on-board recharging of battery pack 49, thereby increasing the time the ISS 70 can operate autonomously without battery recharge from a public power grid or some other recharging means.

The MR 30 is equipped with a sound system 43 as shown in FIG. 3. It comprises a speaker and circuitry that allows it to play appropriate sounds. The VCU 10 instructs the MRs 30 when to emit sound and which sound to play. The samples of sound to play are stored in non-volatile memory in the sound system 43.

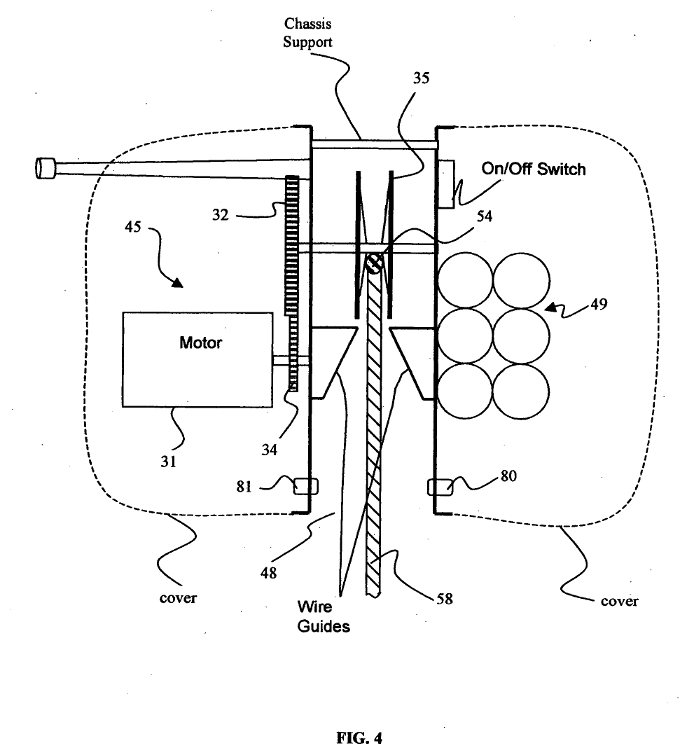

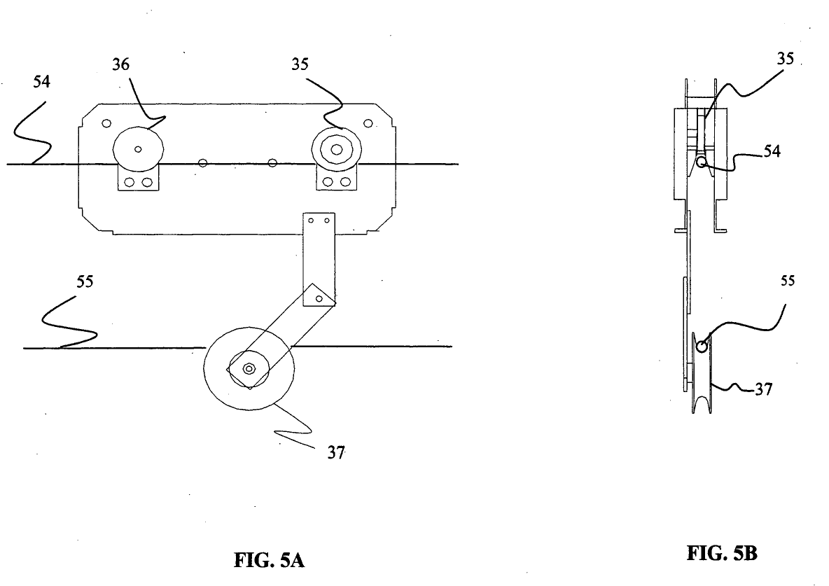

Indexing system 46 and position marker detector 48 are (FIG. 3) used to indicate to the micro controller 44 when the MR 30 has passed over a position marker 58 as shown in FIGS. 1 and 4. The indexing system 46 distinguishes the intermediate markers 58, that are placed at zone boundaries, from end zone markers, i.e. end-of-track-indicators (EOTI) 57 (FIG. 1). EOTI 57 consists of more than one (usually three) marking plates. Intermediate markers 58 can be attached to the upper 55 and lower 54 wires at any location; however, they are also used to support wires 55 and 54 at the intermediate posts 56, as shown in FIG. 1.

The indexing system 46 uses the position marker detector 48 to detect when an MR 30 is passing over a marking plate 58 or over EOTIs 57. It comprises a light emitting diode 80 and a light detector 81 which are mounted as shown in FIG. 4. Each MR 30 is equipped with two marking plate detectors, of which the first is mounted at the front end and the second one is mounted at the rear end of MR 30. For that reason EOTI 57 consists of more than one (usually three marking plates, so that the MR onboard processor 40 can detect an event when light from both light emitting diodes 80 at the front and at the rear of MR 30 is interrupted simultaneously thus signaling that the EOTI is reached, and that MR has to stop.

Battery monitor 47 is used to indicate to the microcontroller 44 the state of the battery pack 49.

The MR 30 is equipped with an RF receiver 42 which receives data from the VCU 10.

Drive system 45, as shown in FIG. 4 propels the MR 30 along the upper wire 54 of the WT 50, and comprises a DC motor 31, gears 32 and 34, and the drive system 45 that controls the DC motor 31.

The MR's 30 microcontroller 44 is responsible for enabling, disabling the MR 30 depending on which of its 2 modes it is in:
Patrol Mode: In this mode, all the systems are enabled and the MR 30 is either waiting to be deployed or is being deployed. The micro controller 44 is controlling the drive system 45 and sound system 43 at the request of the VCU 10; and
Sleep Mode: When the VCU 10 is in Night Mode, it will send a command to MRs 30 to enter Sleep Mode. In this mode, all non-essential systems are switched off to conserve power. In this mode the MR 30 onboard processor 44 is on, and the RF module 42 is switched on at certain time intervals to check if the VCU 10 is switching the ISS 70 to normal patrol operation.

Serial connector 65 is used to upload the calibration file to the VCU 10, and to download the log file for analysis of bird detection.

The WT 50 shown in FIG. 1 is the medium on which the MRs 30 travel. Its main elements are: end-posts 53, intermediate supports 56, support wires 54 and 55, intermediate marking plates 58 and end marking plates 57. Since, there may be a variable number of intermediate supports 56; the maximum length of a WT 50 is variable.

In a typical vineyard application as shown in FIG. 1 one end-post 53 supports wires 54 and 55 at each end of the trellis system. The end-posts have several positions that the wire can attach to; this allows the wire to be strung higher or lower depending on factors such as vineyard slope, height of vines and height of trellis system end-posts.

At one end of the WT 50, the end-post includes a tensioning system 59 to permit adjustment of the tension on the wires 54 and 55. The tensioning system 59 may have an indicator as to how much tension is on the wires.

Intermediate supports 56 may be fixed to the intermediate supports of the trellis system, or implemented as standalone supports. They are used to support wires 54 and 55 between the end-posts 53. Wires 54 and 55 are supported by intermediate marking plates 58 attached to the intermediate support posts 56. The more intermediate supports 56 are used, the less tension must be added to wires 54 and 55 for a given length of sag.

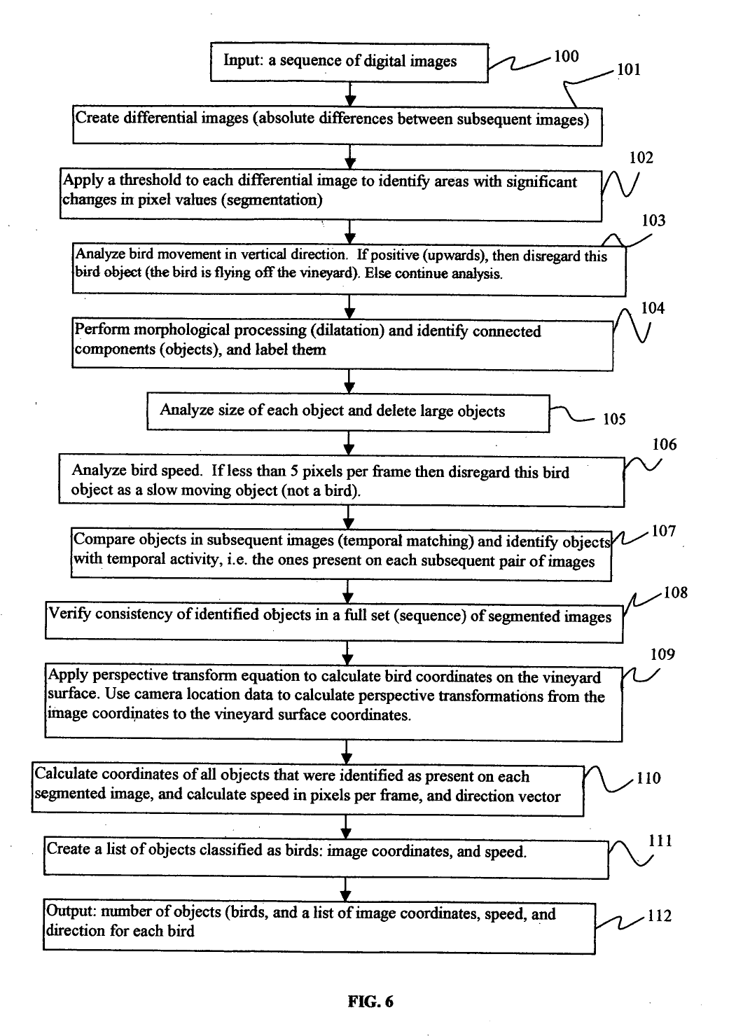

FIG. 6 is a flow chart showing the steps of the bird detection method. Once the input images are available to be processed, the method proceeds to detect birds by:
Capturing a set of consecutive images 100 (usually 3 images);
Detecting temporal activity (101);
Identifying connected components (102, 103, 104);
Matching successive image pairs (105, 106, 107); and
Verifying, calculating coordinates of, and tracking verified objects (108-112).

The temporal activity detection function detects pixels exhibiting temporal activity within the current set of images. If the difference between consecutive intensity values is greater than a given threshold then that pixel is labeled as temporally active; that activity is consistent with a bird motion if it is made of one and only one intensity impulsion. The functions returns, as output, an image containing positive values for active pixels; that number corresponds to the frame number that contains the intensity impulsion when applicable (a frame label).

The connected component analysis function identifies all components in the temporally segmented image. A morphological dilation operation is applied prior to connected component analysis. Any connected component of size larger than a given threshold is rejected. A second connected component pass is then applied that, this time, considers only pixels containing frame labels. It extracts objects made of connected pixels having the same label. The output result is a list of such objects with their respective size, “color” (label index), and associated frame number. Objects that do not have the appropriate area are eliminated to avoid detecting large moving objects like people or cars.

The successive pair matching function matches similar objects. To be a considered as a potential match, the temporal and spatial distances between two objects must be less than a predetermined threshold. Matched objects must have similar size and color. The output is a list of matched pairs with their corresponding velocity.

The object tracking function identifies valid path by chaining the matched pairs. Two pairs can be chained if when the right object of one pair is the same as the left object of the other pair. In addition, the spatial and angular acceleration must remain within a predefined range. All intersecting path are merged. Only traces of sufficient length are retained. Each accepted trace corresponds to a detected bird.

The data calculated by the bird detection process are fed (120 in FIG. 7) into the ISS 70 control procedure FIG. 7 is a flow chart showing the steps of the ISS 70 system control method.

The VCU 10 uses imaging sensor calibration data (121) (location in vineyard coordinate system, and viewing direction defined by three angles: pan, tilt and swing) to perform reverse perspective transformation and calculate bird coordinates on the vineyard surface (122).

After the bird coordinates on the surface are calculated, the closest available MR 30 is deployed (123, 124, 125, 126); and the MR and object locations are updated (127, 128). The following criteria are used: the set of bird coordinates in a queue; the MRs 30 are currently in process of scaring birds (not available), and the position of each MR 30 available for the action within a certain distance (distance between vine rows).

The decision is made to dispatch the closet MR 30 taking into consideration the other birds in a queue, and current and future positions of the MRs (mathematically, this is well known as the “Transportation Problem” or “Assignment Problem”).

Once the MR 30 is identified, the command is generated and sent via the RF module 14. The command contains the MR 30 identification number and the location to which the MR 30 should move.

The new location of MR 30 is stored in the VCU's 10 memory 15, and the log file on MR 30 activity is updated. The particular MR 30 is marked as not available for the time it takes to reach the destination point.

The logging function 128 FIG. 7 is used for event logging purpose when this functionality is desired. Logged data that is stored in a memory 15 can be downloaded to the auxiliary PC 27 via the cable 24.

The foregoing exemplary description and the illustrative preferred embodiments of the present invention have been explained in the drawings and described in detail, with varying modifications being taught. While the invention has been so shown, described and illustrated, it should be understood by those skilled in the art that equivalent changes in form and detail may be made therein without departing from the true spirit and scope of the invention, and that the scope of the present invention is to be limited only to the claims, except as precluded by the prior art. Moreover, the invention as disclosed herein may be suitably practiced in the absence of the specific elements which are disclosed here.

What is claimed is:

1. A bird, animal or the like surveillance and/or deterrence system, comprising:
(a) a video surveillance device (VSD);
(b) an image processing system (IPS) responsive to outputs of said VSD;
(c) means in said IPS for categorizing objects according to size and movement in a defined surveillance area of said VSD; and
(d) a mobile robot responsive to commands from said IPS for moving within said defined surveillance area to closely identify and or deter a moving object.

2. A method for video surveillance of a defined surveillance area, comprising:
(a) providing a digital output of a video surveillance device (VSD);
(b) processing consecutive images from said VSD to identify moving objects;
(c) determining positions, directions and speed of said moving objects; and
(d) providing a data command to a mobile robot to perform a predetermined action within said defined surveillance area.
